(19) United States
(12) Patent Application Publication
(10) Pub. No.: US 2010/0150412 A1
(43) Pub. Date: Jun. 17, 2010

(54) ADAPTIVE PARALLEL ARTIFACT MITIGATION

(75) Inventor: Brent S. Robinson, Kirkland, WA (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/909,748

(22) PCT Filed: Mar. 23, 2006
(86) PCT No.: PCT/IB2006/050896

§ 371 Date: Sep. 26, 2007

Related U.S. Application Data
(60) Provisional application No. 60/665,757, filed on Mar. 28, 2005.

(51) Int. Cl. G06K 9/00

(52) U.S. Cl. 382/128

(57) ABSTRACT

An ultrasound imaging system applies multi-line artifact mitigation during scanning and determines relative motion between the subject being scanned and a transducer array (12) of the ultrasound imaging system. A further jail-bar artifact mitigation is applied only when the relative motion exceeds an excessive motion limit.

The present invention relates to multi-line artifact mitigation in ultrasound imaging during relative motion between ultrasound probe and an object being imaged.

Ultrasonic imaging systems are known, e.g. for producing real-time images of internal portions of the human body. An array of transducers is controlled to produce a transmit (TX) beam which propagates in a predetermined direction from the array. Reflected pressure pulses are received by the receive transducers which may be a sub-set or super-set of the transmit transducers. The reflected pressure pulses may be focused in a receive (RX) beam. Round-trip (RT) beams are, to a first approximation, the multiplication of the TX and RX beams. The collection of transducer compensating delays and signal summing circuitry for forming the transmit, and receive and round trip beams is referred to as a beamformer and is described, for example, in U.S. Pat. No. 4,140,022, which is incorporated herein by reference. The beamformer outputs a radio frequency (RF) signal representing amplitudes of received pressure pulses. A scan converter is disclosed for example in U.S. Pat. Nos. 4,468,747 and 4,471,449, the entire contents of which are incorporated herein by reference, for converting the RF signals output by the beamformer to information in X-Y coordinates used for display of an image on a monitor screen.

The number of lines of data sent to the scan converter is determined by the beam widths of the receive beams. Too few lines results in spatial aliasing which is exhibited as scintillation artifacts in the single lateral dimension for 2D scanning or in elevation and azimuth dimensions for 3D scanning. Scintillation artifacts result when the transducer array is shifted relative to the object. Detection and compression are non-linear operations which increase the lateral spatial frequency band widths. Accordingly, even if the beams going into the detector are not spatially aliased, it is possible that they exhibit spatial aliasing at the output of the detector.

U.S. Pat. Nos. 5,318,033 and 5,390,674 disclose a method for overcoming the problem of spatial aliasing by laterally upsampling using an interpolation filter for filtering the RF signals output by the beamformer. In this method, the TX, RX, and RT beams are collocated and the upsampling is performed on the RT beams. FIG. 1 depicts the (lateral) TX and RX coordinate space for one lateral dimension of the ultrasound scan. The “+” signs in FIG. 1 represent beam locations. In this case, the RT beams are collocated with the TX and RX beams. Lateral RF interpolation, as described above, is shown in FIG. 2. RT beams 3 and 4 are synthesized by interpolating RT data acquired at TX and RX beam locations 1 and 2.

According to receive multi-line imaging techniques more than one RX beam is acquired for each TX beam. Accordingly, there are more RT beams available for the detector, one for each TX/RX beam pair. The RX beams are displaced from the TX beam so that the RX beams straddle the TX beam. FIG. 3 shows conventional 2× multi-line imaging with two receive beams for each transmit beam (the exact locations of the RT beams are not shown in FIG. 3). In multi-line imaging, each of the plural RT beams associated with a transmit beam is referred to as a different type of line, i.e., type A, type B, and so on. In general, all type A beams have common characteristics such as, for example, amplitude response, phase response, and asymmetry in the beam pattern.

In multi-line imaging, the location of each RT beam is displaced from both the constituent TX and RX beams. The RT beams are asymmetrical and the amplitudes of the RT beams are less than if the TX and RX beams are collocated. The displacements, asymmetries and amplitude losses associated with the RT beams cause jail-bar artifacts (alternating groupings or stripes aligned in the axial scan direction). Jail-bar artifacts are different from scintillation artifacts in that jail-bar artifacts occur even when there is no motion. TX focus is fixed and RX focus is dynamic. Therefore, the displacements, asymmetries, and amplitudes associated with the RT beams, and thus the jail-bar artifacts, are depth dependent. Jail-bar artifacts may be reduced by broadening or flattening the TX beams as described in U.S. Pat. Nos. 4,644,795 and 6,585,648 or by lateral filtering following the detector or compressor. However, these approaches tend to reduce lateral resolution.

Multi-line Artifact Mitigation (MAM), also referred to as Parallel Artifact Mitigation (PAM), is a technique for eliminating or at least reducing jail-bar artifacts while preserving spatial resolution and is described in U.S. Pat. No. 5,318,033. Various schemes exist, but a common element in all of the MAM schemes is that a filter is applied to received multi-line data prior to detection (the standard form of RF interpolation for scintillation reduction operates on collocated TX, RX, and RT data or, in other words the case of no multi-line). The two or more RT beams that are filtered typically arise from either different RX beam locations arising from a common TX beam or RX beams at the same location arising from different TX beams, i.e. common TX and common RX, respectively. MAM improves mutual similarities between all synthesized RT beams.

However, MAM assumes that the tissue is stationary with respect to the ultrasound probe. Excessive motion reintroduces jail-bar artifacts because the phases of RF data used in MAM varies from that assumed resulting variable amounts of destructive interference.

Excessive motion is defined as motion causing displacements of approximately ⅕ wavelength of the ultrasound signals during the period between successive transmit events used to synthesize the data. For 2D scanning, this period is typically about 200 μsec. At 3 MHz and a wavelength of 0.5 mm, the excessive motion is reached at an axial velocity of approximately 25 cm/sec. For 3D scanning there is typically a fast scan and slow scan dimension. The period between transmit events in the fast scan dimension is about the same as for 2D scanning. However, the period between transmit events in the slow scan dimension may be as high as 25 times larger, reducing the excessive motion axial velocity threshold to approximately 1 cm/sec.

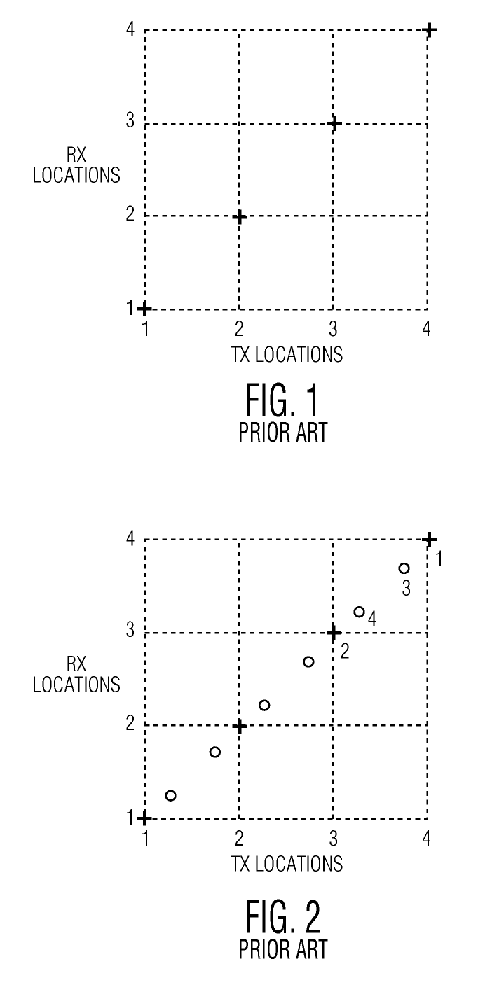

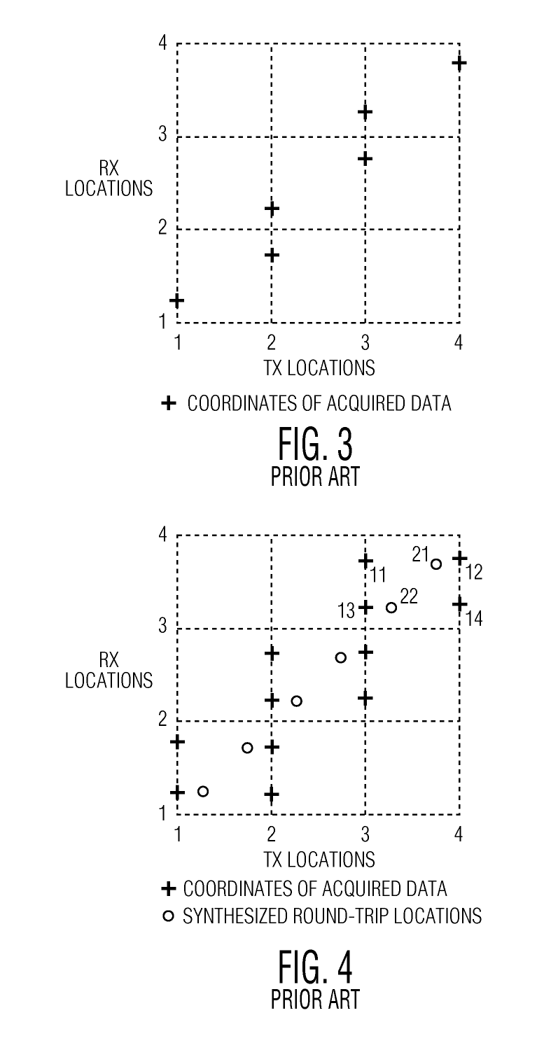

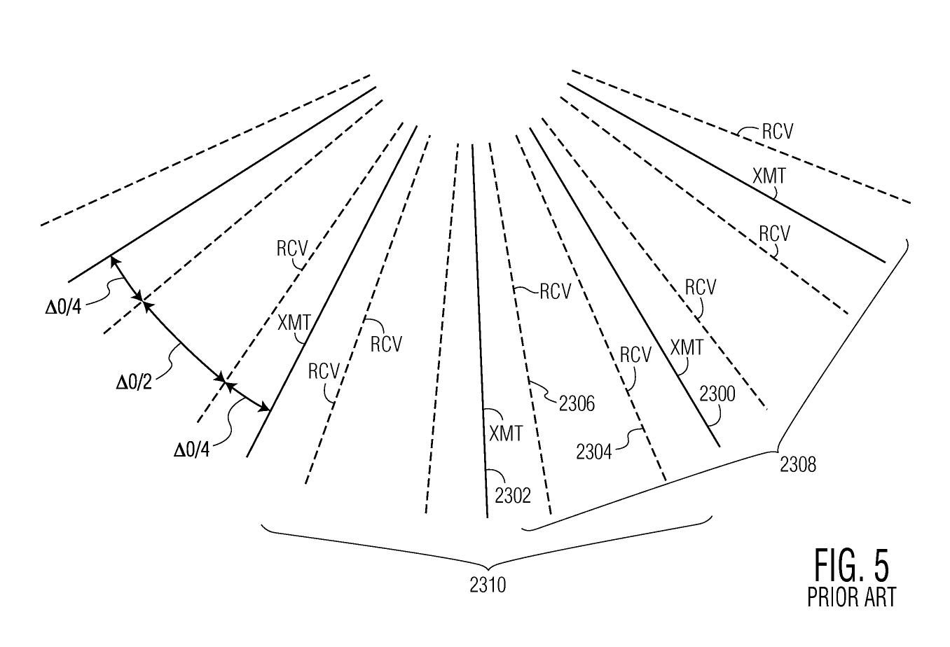

FIGS. 4 and 5 of the present application illustrate an exemplary implementation of MAM referred to as 4×-2×, wherein four RX lines are generated for each TX line. The RX lines are then combined to form 2 lines for each TX line. This implementation of MAM is also disclosed in U.S. Pat. No. 5,318,033. In FIG. 4 of the present application, synthesized beam 21 is a result of an interpolation between RT beams 11 and 12. Similarly, synthesized beam 22 is the result of an interpolation between RT beams 13 and 14. Because the acquired beam pairs, i.e. 11, 12 and 13, 14 are at common receive locations, the interpolation is in TX space only.

FIG. 5 is a diagrammatic one-dimensional representation showing the spatial relationship of synthesized round trip beam information to transmit beam information using 4×-2× MAM and receive information from four parallel beams. It is possible to use four parallel beamformers to generate four parallel outputs. As in the line synthesis techniques described above, the outputs of each beamformer are stored in memory. The stored outputs are subsequently pieced together in a linear combination to synthesize round-trip lines for subsequent detection, compression, scan-conversion, and display. This combination results in the synthesized beams of FIG. 5. The actual transmit beams are schematically illustrated as solid lines. The dotted lines in FIG. 5 represent locations of both the synthesized round trip beams and the receive beams.

In the example of FIG. 5, all RT beams are synthesized from two TX beams. For example, RT beams 2304 and 2306 are synthesized from data received from TX beams 2300 and 2302. Brackets 2308 and 2310 identify groups of parallel RX beams corresponding to TX beams 2300 and 2302 respectively. This “four beam to 2 beam” MAM method is advantageous in that all synthesized beams have virtually identical beam profiles for all round-trip angles, thereby eliminating jail-bar (or “checkerboard”) line artifacts when the targets being scanned are stationary or nearly stationary with respect to the ultrasound probe. Yet, there is an undesirable susceptibility of MAM to object motion as well as motion of ultrasound probe.

An object of the present invention is to eliminate or at least reduce jail-bar artifacts in ultrasound imaging caused by relative motion between the ultrasound probe and the subject being imaged.

The object of the present invention is met by a method of ultrasound imaging including scanning a patient or object using an ultrasound probe, monitoring for excessive relative motion between the object being imaged and the ultrasound probe, and implementing a jail-bar reduction process when excessive relative motion is detected.

Methods to detect the motion include image analysis, Doppler analysis, jail-bar detection, or use of a motion detector within the ultrasound probe. The relative motion may be caused by motion of the ultrasound probe, motion of object, or part of the object (i.e., beating heart or heart values), or a combination thereof. Excessive motion is generally defined as motion which causes jail-bar artifacts. The threshold of excessive motion will be different for different scanning modes. While the excessive speed is lower, and therefore more easily surpassed, in 3D imaging, the techniques of the present invention may be applied to 2D imaging of rapidly moving structures, such as a heart value.

When imaging a 3D volume with a 2D array which produces a single transmit beam per transmit firing, scanning may be effected similarly to a TV raster scan in which the transmit beam is scanned across one row rapidly (fast scan dimension). Once one row is completely scanned, the next row down is scanned, the vertical dimension being a slow scan dimension. The technique according to the present invention is particularly suitable for eliminating jail-bar artifacts in the “slow scan” dimension of the above-described TV raster scanning method.

Methods which may be used to reduce jail-bars includes reducing or turning off the MAM and implementing a further jail-bar reduction technique such as for example, spatial filtering, temporal filtering, dropping multi-line order, beam broadening, and normalization of average A-line amplitudes between lines.

Alternatively, the MAM may be maintained and the RF data may be pre-aligned to counter the misalignment caused by the relative motion between the ultrasound probe and the object being imaged.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

In the drawings:

FIG. 1 is a graph depicting TX beam and RX beam according to standard imaging in which the beams are collocated;

FIG. 2 is a graph depicting lateral RF interpolation of the TX and RX beams to acquire RT beams;

FIG. 3 is a graph depicting TX and RX beam locations according to 2× multi-line imaging;

FIG. 4 is a graph depicting multi-line artifact mitigation in which four RX beams are generated for each TX beam;

FIG. 5 is another view of the RX beams generated by one TX beam as in FIG. 4;

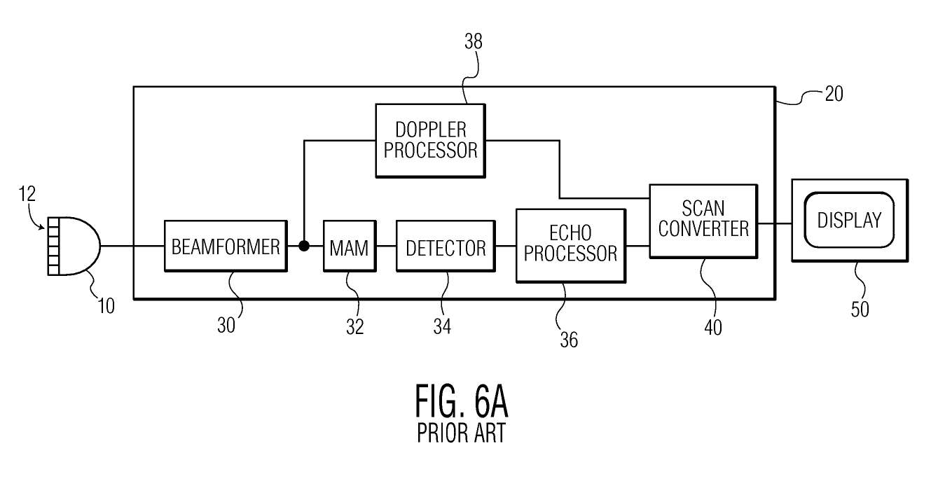

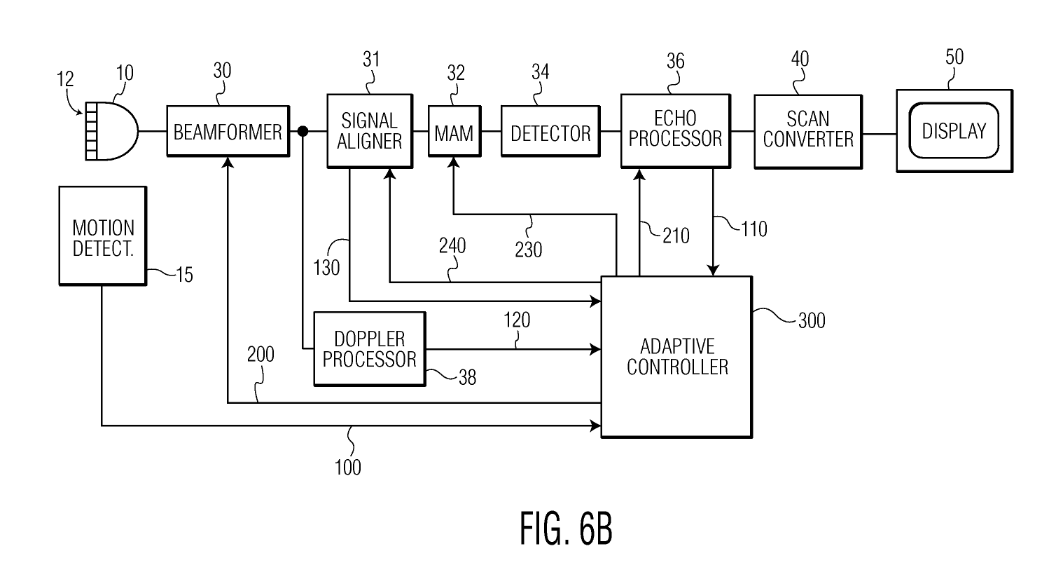

FIG. 6A is a schematic diagram showing the main components of an ultrasonic imaging system in which prior art multi-line artifact mitigation is implemented;

FIG. 6B is a schematic diagram showing the main components of an ultrasonic imaging system in which the present invention is implemented;

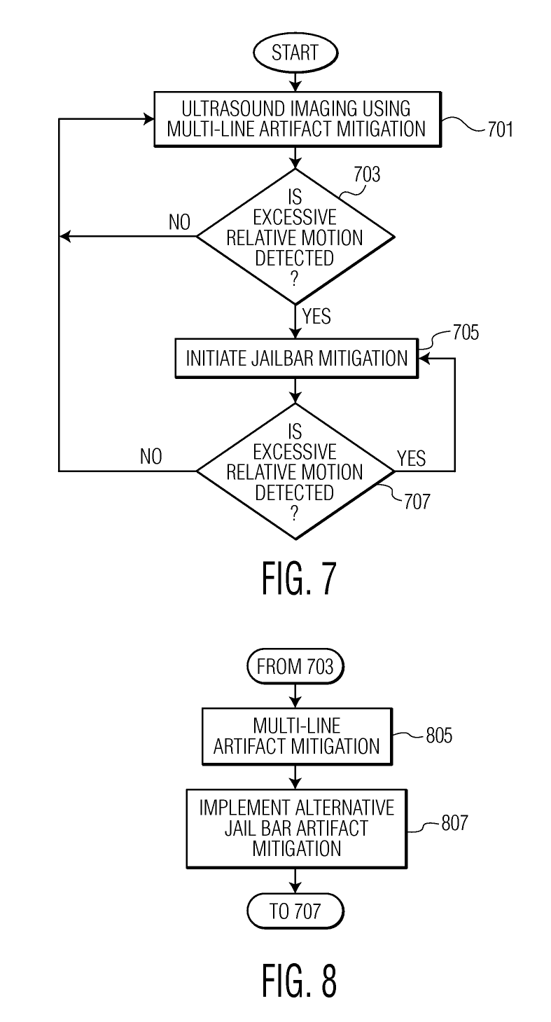

FIG. 7 is a flow diagram showing the steps according to the present invention;

FIG. 8 is a flow diagram showing the steps according to an embodiment of jail-bar artifact mitigation;

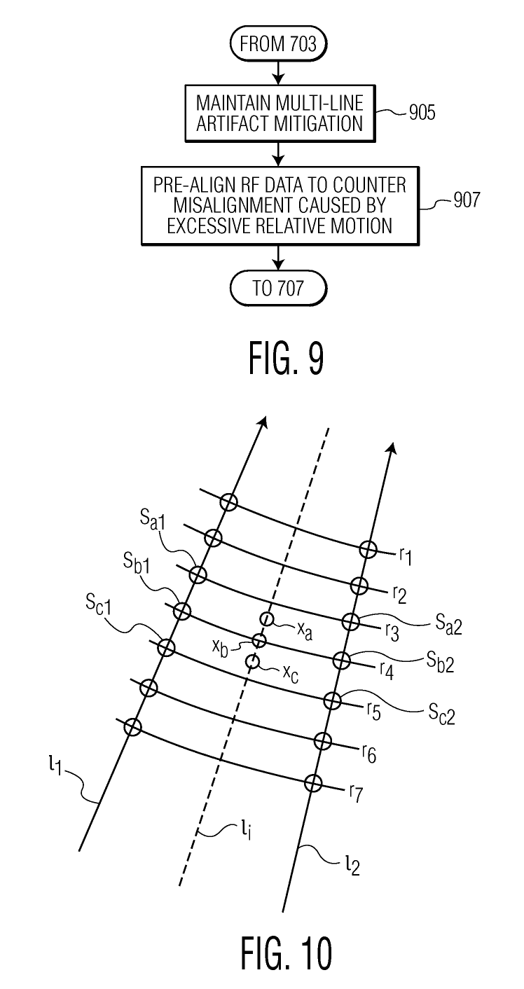

FIG. 9 is a flow diagram showing the step of another embodiment of jail-bar artifact mitigation;

FIG. 10 is a schematic diagram illustrating the axially adaptive interpolation of a scan line between two received scan lines of a sector scanned image; and

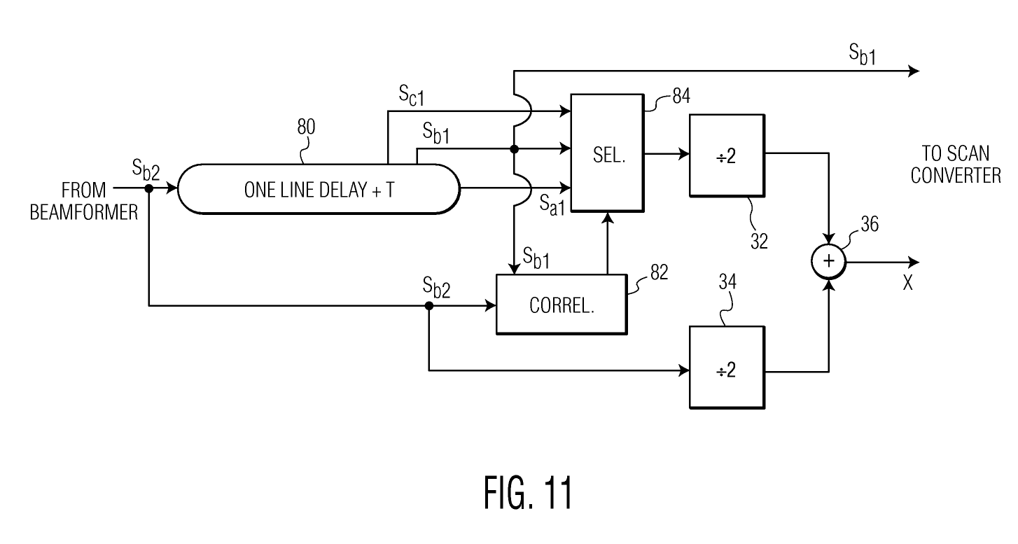

FIG. 11 is a block diagram showing an adaptive line interpolator according to the present invention.

FIG. 6A is a schematic diagram showing the major components of a prior art ultrasound imaging system in which the present invention may be implemented. An ultrasound probe 10 having plural transducers 12 is connected to a controller 20 having a beamformer 30, a Multi-line Artifact Mitigation (MAM) unit 32, a detector 34, an echo processor 36, Doppler processor 38 and a scan converter 40. As is known, the beamformer 30 controls the transducers 12 to transmit a TX beam and receive RX beams from an object to be imaged. The beamformer 30 generates RF data in response to the RX beams. MAM unit 32 combines receive multi-line RF data in order to reduce or eliminate multi-line artifacts prior to determination of the echo envelope by detector 34. The RF data output from the beamformer 30 may also be subject to band pass filters and additional line interpolators (not shown) arranged anywhere between the beamformer 30 and the detector 34. The signal may then undergo further signal conditioning including compression, axial and lateral filtering in the echo processor 36. The scan converter 40 translates the processed echo data into image data which correlates to X-Y coordinates which can be reproduced on the monitor 50 so that a brightness mode (B-mode) image of the subject may be viewed by an observer. The Doppler processor 38 extracts motion information by detecting changes in phase of the received signals for successive transmit events. The motion information can be overlayed with the B-mode information within scan-converter 40 to produce a color Doppler image.

FIG. 6B is a schematic diagram showing the major components of an ultrasound imaging system in which the present invention may be implemented. A probe motion detector 15, a signal aligner 31, and an adaptive controller 300 are added to the prior art system depicted in FIG. 6A. The adaptive controller 300 receives motion information from at least one of the probe motion detector 15, the Doppler processor 38, the signal aligner 31, or the image analysis block within echo processor 36 by signal lines 100, 120, 130, 110, respectively. Alternatively, or in addition, adaptive controller 300 receives information on the jail-bar level from a jail-bar detector within echo processor 36 by the signal line 110. Adaptive controller 300 compares the amount of motion or jail-bar level with a pre-determined threshold and, adjusts the amount of multiline artifact mitigation applied in the MAM unit 32 accordingly using control line 230. At the same time the adaptive controller 300 sends control information to beamformer 30, signal aligner 31, and/or echo processor 36 to adjust the amount of jail-bar reduction performed in these blocks using control lines 200, 240, and 210, respectively.

FIG. 7 is a flow chart illustrating the steps for eliminating or reducing jail-bar artifacts caused by relative motion between ultrasound probe 10 and the subject being imaged i.e., motion-induced jail-bars (MIJ) artifacts. At step 701, ultrasound imaging of an subject is performed using multi-line artifact mitigation. The relative motion between the ultrasound probe and the object being imaged is monitored and a determination is made whether the relative motion exceeds an excessive motion value, step 703. The excessive motion value is preferably a predetermined threshold value at which MIJ artifacts occur. The excessive motion value depends on the type of ultrasound imaging being used. For example, 2D imaging allows much greater velocities of movement than does 3D imaging before jail-bar artifacts are formed (i.e., 3D imaging is less tolerant of relative movement). Furthermore, the relative motion may be caused by movement of the probe 10 and/or physiological movement within the image being scanned such as, for example, moving heart valves. The excessive motion may be in the range of ⅓ to 1/16 wavelength between successive transmissions of the transmit beams which are used for multi-line artifact mitigation. For example, the excessive motion may be ⅕ wavelength between successive transmissions of transmission beams used for multi-line artifact mitigation.

The determination of relative motion may be accomplished by image analysis, Doppler analysis, jail-bar detection, a motion sensor arranged in or associated with the ultrasound probe 10 or any other known or hereafter developed apparatus or technique. Image analysis compares correlations between successive image data to determine whether something has moved. This is typically performed after the beamformer RF output data has been detected and log-compressed within the echo processor 36 with feedback path 110 as depicted in FIG. 6B. Doppler analysis is similar to image analysis but is performed on the RF data output from the beamformer 30 or demodulated (quadrature) data in, e.g., the Doppler processor 38 shown in FIG. 6B.

Jail-bar detection analyzes the image or region of interest for jail-bars. This may include comparing brightness of type A synthesized lines to type B synthesized lines. Alternately, type A lines in a position P are compared to type B lines at position P at a later time. A disadvantage of the jail-bar detection approach is the need to periodically return to standard MAM in order to see if the motion has subsided.

The motion sensor may include a position, velocity, or acceleration detector arranged in the ultrasound probe. An example of this type of motion sensor is disclosed in U.S. Pat. No. 4,852,577. Other examples of motion detectors include magnetic position devices, such as the “Flock of Birds®” sensor manufactured by Ascension Technologies (Burlington, Vt.) or the “FASTRAK®” from Polhemus (Colchester, Vt.), and video imaging of markers on probes used to detect probe motion.

If excessive motion is detected, jail-bar mitigation is implemented, step 705. The jail-bar mitigation implemented at step 705 is maintained until the excessive motion is no longer detected, step 707.

FIG. 8 shows one technique for jail-bar mitigation according to the present invention. At step 805, the MAM is disabled or reduced and at step 807 an alternative artifact mitigation procedure is implemented. The alternative methods for reducing artifacts in step 807 include at least one of spatial filtering, temporal filtering combined with interleaved line acquisition, dropping multiple line orders, beam broadening (reducing aperture size of the RX and TX transmissions), normalization of average amplitudes of all line types, or any other known or hereafter developed technique.

The spatial filtering method applies a lateral low pass filter to the area in which excessive motion is detected. This equalizes the response of each beam but at the expense of blurring the image.

Temporal filtering with line interleaving flips the type A and type B line positions between frames (i.e., volumes in 3D imaging) and applies a heavy time average. An example of temporal filtering is disclosed in U.S. Pat. No. 5,980,458, the entire contents of which are incorporated herein by reference.

Dropping multi-line order includes dropping back from a high order multi-line such as 4× to a lower order multi-line such as 2× (i.e., 2 RX beams per TX beam). It is easier to control jail-bars in lower order multi-line with a post-detection lateral filter (i.e., a filter within echo processor 36 of FIG. 6B). At low line densities, dropping the multi-line order may increase scintillation artifacts. Multi-line order would be set in beamformer 30 of FIG. 6B by feedback from adaptive controller 300 on control path 200 in FIG. 6B.

Reduction of the TX and RX apertures increases the beam sizes. This blurs the image but reduces certain types of jail-bars. Aperture sizes would be set in beamformer 30 of FIG. 6B by feedback from adaptive controller 300 on control path 200 in FIG. 6B.

Normalization determines the differences in average amplitudes of the various line types (i.e., A, B, C, D, etc.) and applies gains so the average brightnesses are equal between lines of different types. Normalization would be implemented in echo processor 36 and controlled by adaptive controller 300 via control path 210 in FIG. 6B.

FIG. 9 shows another embodiment for jail-bar mitigation according to the present invention. According to FIG. 9, the RF data output from the beamformer 30 are pre-aligned in the signal aligner 31 to counter the misalignment caused by the relative motion between the ultrasound probe and the subject being imaged, step 905, and the MAM is maintained, step 907. FIGS. 10-11 show one embodiment of signal aligner 31 and associated motion estimator. The system of FIG. 11 is further described in U.S. Pat. No. 5,390,674, the entire contents of which are incorporated herein by reference

For the sample sequence shown for lines l₁ and l₂ in FIG. 10, sample S_{b2} of line l₂ is applied to the input of the delay line 80 at the same time as sample Sₐ₁ is produced at the output of the delay line. The delay line has two taps, separated from the output by one sample period and two sample periods, respectively, at which samples S_{b1} and S_{c1} are produced at the time that sample Sₐ₁ appears at the output of the delay line.

A number of samples from the two lines l₁ and l₂, taken from the input and the first tap of the delay line, respectively, are applied to a correlator 82. The correlator performs a cross-correlation of range aligned data samples of the two lines l₁ and l₂ to detect the condition of relative motion between the two lines. This cross correlation is performed in the conventional manner by sequentially shifting sample sequences from the two lines relative to each other, multiplying aligned samples after each shift, and summing the products to produce a correlation factor. The value and direction of shift for which the correlation factor is at a maximum indicates the amount and direction of motion that has occurred in the period between the acquisition of the two lines l₁ and l₂. The peak of the correlation factor is then used as the control input of a selector or multiplexer 84 to select the sample at the input of the selector which would, in the absence of motion, be range-aligned with the sample at the input of the delay line 80.

Thus, when sample S_{b2} of line l₂ is at the input of the delay line and there is no motion when the line samples are acquired, there would be a high degree of correlation between the two lines when no relative shift occurred, indicating no motion. The selector 84 would then select sample S_{b1} to be used in calculating an interpolated value X_{b} with sample S_{b2} at the output of summer 36. As shown in FIG. 10, these two samples are at the same range r₄ in this example.

But when there is motion away from the receiver (in a direction opposite that of the arrowheads in FIG. 10), the correlator 82 will detect the motion and its direction. In the example the selector 84 would select sample Sₐ₁ to be used in interpolation with sample S_{b2}. An interpolated value Xₐ is then computed at the output of summer 36 using these two sample values. By virtue of the motion, the value Xₐ is seen to be at a half range increment between ranges r₃ and r₄ in FIG. 10.

In a similar manner motion toward the receiver would be detected by the correlator 82 and sample S_{c1} would be selected to be used with sample S_{b2} to interpolate value X_{c}, again at a range half increment due to motion.

The interpolated values may be at fractional range increments as the foregoing example illustrates. To bring the samples back into alignment with the same ranges as the received lines, the interpolated line values can be processed through an axial transversal filter with coefficients chosen to compute an interpolated value at each whole range increment along the interpolated line. This alignment would be useful if further line filtering were to be done using a multitap filter, for instance, or if the scan converter requires sample data points to be spatially organized in a uniform grid or pattern.

While the embodiment of FIG. 11 adapts the interpolater to account for axial motion, it will be apparent that an adaptive technique can be employed to account for motion in the lateral direction also. A correlation can be performed laterally across the aperture using the signal values at two adjacent r distances. If lateral motion is detected, the values of affected signal samples can be adjusted by a weighting or interpolative technique in consideration of the values of adjacent signal samples.

The above-embodiments describe a single threshold control in which the jail-bar artifact mitigation is either on or off. However, a graduated control may also be implemented in which one of a plurality of levels of jail-bar artifact mitigation is implemented depending the level of relative motion. Instead of a graduated control, a continuous control, i.e., sliding scale, approach may be also be implemented, wherein jail-bar artifact mitigation is initiated when excessive motion is detected and the degree of jail-bar mitigation is increased as the relative motion increases.

Thus, while there have been shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1. A method for reducing or eliminating motioned-induced jail-bar artifacts in an ultrasound imaging system that includes a transducer array (12), a beamformer (30) producing RF data from pressure pulses received by the transducer array, a detector (34) for processing the RF data output by the beamformer, a scan converter (40) for converting the processed RF data to image data in an image data format, and a display (50) for displaying an image of the scanned subject based on the image data, the method comprising the steps of
(a) scanning, by the transducer array (12), a subject to be imaged and applying multi-line artifact mitigation to the scanned data;
(b) determining whether relative motion between the transducer array and the subject to be image exceeds an excessive motion limit;
(c) if the excessive motion limit is exceeded, initiating a jail-bar artifact mitigation.

2. The method of claim 1, further comprising the step of maintaining the jail-bar artifact mitigation in effect until the relative motion is below the excessive motion limit.

3. The method of claim 1, wherein said step of initiating a jail-bar artifact mitigation comprises applying an alternative artifact reduction technique.

4. The method of claim 1, wherein the step of determining includes using image analysis of the image data.

5. The method of claim 1, wherein the step of determining includes using Doppler analysis of the RF data.

6. The method of claim 1, wherein the step of determining includes jail-bar detection for determining the difference in brightness between different line types of data produced by the multi-line artifact mitigation.

7. The method of claim 1, wherein the step of determining includes using a motion sensor within or associated with the transducer array.

8. The method of claim 3, wherein the alternative artifact reduction technique includes spatial filtering by applying a lateral low pass filter to the received data.

9. The method of claim 3, wherein the alternative artifact reduction technique includes temporal filtering combined with interleaved line acquisition.

10. The method of claim 3, wherein the alternative artifact reduction technique includes dropping or reducing the order of the multi-line artifact mitigation procedure.

11. The method of claim 10, wherein the alternative artifact reduction technique includes dropping or reducing the order of the multi-line artifact mitigation procedure to an order of 2× or less.

12. The method of claim 1, wherein said step of initiating a jail-bar artifact mitigation comprises maintaining the multi-line artifact mitigation procedure in effect and pre-aligning the RF data output by the beamformer to counter the misalignment caused by the relative motion.

13. The method of claim 1, wherein said step of scanning comprises 3D scanning.

14. The method of claim 1, wherein said step of scanning comprises 2D scanning.

15. The method of claim 1, wherein the relative motion exceeds the excessive motion limit only in a portion of the scanned area or volume, said step (c) is applied only to the portion in which the excessive motion limit is exceeded.

16. The method of claim 1, wherein the excessive motion limit is dependent on a type of scanning being performed in said step (a).

17. The method of claim 1, wherein the excessive motion limit is in the range ⅓- 1/16 wavelength between successive transmissions of transmit beams used for multi-line artifact mitigation.

18. The method of claim 1, wherein one of a plurality of levels of jail-bar artifact mitigation is implemented depending on the level of the relative motion.

19. The method of claim 3, wherein said step of initiating a jail-bar artifact mitigation further comprises reducing or disabling the multi-line artifact mitigation.

20. An ultrasound imaging system for reducing or eliminating motion-induced jail-bar artifacts, the system comprising:
a transducer array (12) for gathering image data; and
an image processing mechanism (300, 30, 31, 32, 34, 36, 40) including a beamformer (30) for receiving pressure pulses from the transducer array and generating RF data and a scan converter (40) for converting the RF data to image data in an image data format, wherein the image processing mechanism is arranged and dimensioned for applying a multi-line artifact mitigation to the ultrasound image, determining whether relative motion between the transducer array and the subject to be image exceeds an excessive motion limit, and initiating further jail-bar artifact mitigation if the relative motion exceeds the excessive motion limit.

21. The ultrasound imaging system of claim 20, wherein said image processing mechanism (300, 30, 31, 32, 34, 36, 40) is further arranged and dimensioned for maintaining the further jail-bar artifact mitigation in effect until the relative motion is below the excessive motion limit.

22. The ultrasound imaging system of claim 20, wherein said jail-bar artifact mitigation comprises applying an alternative artifact reduction technique.

23. The ultrasound imaging system of claim 20, wherein said image processing mechanism (300, 30, 31, 32, 34, 36, 40) is arranged and dimensioned for determining relative motion using image analysis of the image data.

24. The ultrasound imaging system of claim 20, wherein said image processing mechanism (300, 30, 31, 32, 34, 36, 40) is arranged and dimensioned for determining relative motion using Doppler analysis of the RF data.

25. The ultrasound imaging system of claim 20, wherein said image processing mechanism (300, 30, 31, 32, 34, 36, 40) is arranged and dimensioned for determining relative motion using jail-bar detection for determining the difference in brightness between different line types of data produced by the multi-line artifact mitigation.

26. The ultrasound imaging system of claim 20, further comprising a motion sensor (15) within or associated with said transducer array, wherein said image processing mechanism (300, 30, 31, 32, 34, 36, 40) is arranged and dimensioned for determining relative motion using said motion sensor.

27. The ultrasound imaging system of claim 22, wherein the alternative artifact reduction technique includes spatial filtering by applying a lateral low pass filter to the received data.

28. The ultrasound imaging system of claim 22, wherein the alternative artifact reduction technique includes temporal filtering combined with interleaved line acquisition.

29. The ultrasound imaging system of claim 22, wherein the alternative artifact reduction technique includes dropping or reducing the order of the multi-line artifact mitigation procedure.

30. The ultrasound imaging system of claim 29, wherein the alternative artifact reduction technique includes dropping or reducing the order of the multi-line artifact mitigation procedure to an order of 2× or less.

31. The ultrasound imaging system of claim 20, wherein said further jail-bar artifact mitigation includes maintaining the multi-line artifact mitigation procedure in effect and pre-aligning the RF data output by the beamformer (30) to counter the misalignment caused by the relative motion.

32. The ultrasound imaging system of claim 20, wherein said transducer array (12) and image processing mechanism (300, 30, 31, 32, 34, 36, 40) are arranged and dimensioned for 3D scanning.

33. The ultrasound imaging system of claim 20, wherein said transducer array (12) and image processing mechanism (300, 30, 31, 32, 34, 36, 40) are arranged and dimensioned for 2D scanning.

34. The ultrasound imaging system of claim 20, wherein said image processing mechanism (300, 30, 31, 32, 34, 36, 40) is arranged and dimensioned for determining when the relative motion exceeds the excessive motion limit only in a portion of the scanned area or volume and applying the further jail-bar artifact mitigation only to the portion in which the excessive motion limit is exceeded.

35. The ultrasound imaging system of claim 20, wherein the excessive motion limit is dependent on a type of scanning being performed.

36. The ultrasound imaging system of claim 20, wherein the excessive motion limit is in the range ⅓ to 1/16 wavelength between successive transmissions of transmit beams used for multi-line artifact mitigation.

37. The ultrasound imaging system of claim 20, wherein one of a plurality of levels of jail-bar artifact mitigation is implemented dependent on a level of the relative motion.

38. The ultrasound imaging system of claim 22, wherein said jail-bar artifact mitigation further comprises reducing or disabling the multi-line artifact mitigation.
